(19) United States
(12) Patent Application Publication
(10) Pub. No.: US 2010/0201134 A1
(43) Pub. Date: Aug. 12, 2010

(54) Gravity-based electrical energy production system

(76) Inventor: Murat Erdogan, Hillsboro, OR (US)

Correspondence Address: ATER WYNNE LLP, 1331 NW Lovejoy St. Suite 900, PORTLAND, OR, 97209-2785, US

(21) Appl. No.: 12/658,740

(22) Filed: Feb. 4, 2010

Related U.S. Application Data
(60) Provisional application No. 61/207,039, filed on Feb. 6, 2009.

(51) Int. Cl. H02K 7/18; H02K 53/00

(52) U.S. Cl. 290/1 C; 415/916

(57) ABSTRACT

A rotating-energy electrical production system includes an elongate central substantially vertically extending bar structure including an exterior helical thread portion extending therearound from an upper region thereof to lower region thereof, and a free-to-rotate disk structure encircling the bar structure, the disk structure having an interior helical thread portion engaging the exterior helical thread portion of the bar structure for helically winding counter-rotation therebetween under the force of gravity acting on the disk structure.

### RELATED APPLICATIONS

This application claims the benefit of priority to U.S. Non-Provisional application No. 61/207,039, filed on Feb. 6, 2009 and entitled GRAVITY-BASED ENERGY PRODUCTION APPARATUS, SYSTEM AND METHOD, the contents of each of which are hereby incorporated herein in their entirety by this reference.

### FIELD OF THE INVENTION

The invention relates generally to the field of electrical energy production. More particularly, the invention relates to using gravity to produce electrical energy.

### BACKGROUND OF THE INVENTION

Those of ordinary skill in the art of course are familiar with water wheel power generators that essentially feature buckets or vanes radially extending from a central spindle, the vanes being deflected and rotated by running water to produce electricity. More recently, U.S. Pat. No. 7,067,932 B1 to Ghassemi taught generating electricity by using a gravitational mass and the momentum of a motor vehicle that drives over an oscillating ramp.

### BRIEF DESCRIPTION OF THE DRAWINGS

FIGS. 1A, 1B, and 1C illustrate alternative spindle or bar and disk configurations for an electrical energy production system in which a mass such as a disk is made to helically rotate down a spindle or bar and the kinetic energy from such mechanical motion is converted to electricity.

FIGS. 2A-2B illustrate alternative ball bearing/wheel guidance configurations for helically tracking down the bar.

FIGS. 2C-2E illustrate assembled multiple-disk drive configurations.

FIGS. 3A1-3A2 illustrate alternative side-by-side, disk-to-disk drive configurations.

FIG. 3B1-3B2 illustrate alternative power conveyance configurations.

FIG. 3C1-3C2 illustrate alternative gear bar drive configurations.

FIG. 3D illustrates a generator-on-disk configuration.

FIG. 4 illustrates alternative disk and bar configurations including a single disk on a bar, multiple single disks on a bar, and multiply connected (ganged) disks on a bar.

FIG. 5A is an isometric view illustrating a unit-on-a-rotational-wheel frame configuration for elevating a ‘fallen’ disk.

FIG. 5B illustrates multiple ones of such rotational wheel frames ganged together and operated by a common motor.

FIG. 6A is a front elevation illustrating the rotational wheel frame configuration.

FIG. 6B illustrates a disk disengagement mechanical lock for elevating a ‘fallen’ disk.

FIG. 6C illustrates a small motor on disk for elevating a ‘fallen’ disk.

FIG. 6D illustrates a small motor on the spindle for elevating a ‘fallen’ disk.

FIG. 6E illustrates retractable ball bearings or wheels for elevating a ‘fallen’ disk.

FIGS. 7A and 7B are alternative isometric views of the electrical energy production system installed within a high-rise building, for example, wherein two or more of the invented apparatus are controlled by a controller and perhaps ganged, e.g. connected in series or parallel, thereby to multiply electrical energy production to feed excess electrical power to a power grid.

### DETAILED DESCRIPTION OF THE PREFERRED EMBODIMENTS

The invention involves gravity-based energy conversion/production systems and methods by which weighted objects rotate helically along a track of a vertically oriented worm screw (or structural equivalent—e.g. a twisted, square-cross-sectional spindle or bar) to convert potential energy to kinetic energy converted to electricity by a generator.

“Grid” as used herein broadly refers to an electrical power collection and/or distribution and/or transmission network. In other words, grid may refer to a relatively small local grid such as one contained within a neighborhood, city block, or high-rise building. Alternatively, grid may refer to a relatively large distributed grid such as an electrical utility, district, or state-wide or multi-state agency. Such a grid may be metered or not, i.e. it may or may not measure electrical power consumption and production, and the net difference therebetween at its ‘border’, and it may or may not extend credits or other compensation for positive net differences therebetween.

Those of skill in the art will appreciate by reviewing the drawings that disk herein is labeled D, bar herein is labeled B, motor herein is labeled M, generator herein is labeled G, and clutch herein is labeled C, all illustrated consistently (but selectively, for the sake of clarity and simplicity) throughout the drawings.

In accordance with a first embodiment of the invention, a disk-shaped object is caused to rotate under gravity along a helical track in a worm screw bar that is vertically mounted, e.g. atop the ground, or within a building or underground shaft. The object is affixed to the worm screw such that minimum friction is encountered, e.g. via ball bearings, other rolling friction, or truly frictionless (e.g. magnetic levitation (‘maglev’ for short), although maglev is believed to present some unique problems as well such as back-electromotive force (EMF) or other built-in physical or electrical frictional effect) arrangements. Those of skill in the art will appreciate that alternative bearing arrangements, e.g. wheels, sleeve bearings or lubricated surfaces, are contemplated as being within the spirit and scope of the invention. The “falling” weight and kinetic energy of the object is used to generate and store electricity by any suitable means, e.g. gears and brushes as in a generator, brushless linear induction, or the like.

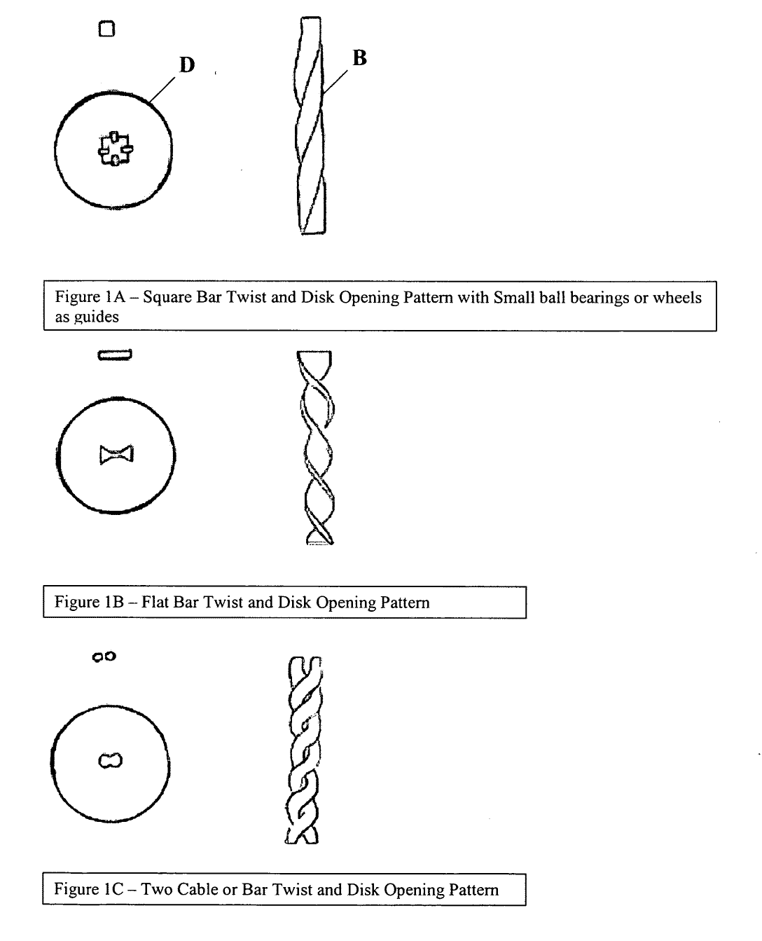

When the helically or spirally moving object hits bottom, it is power-returned to the top of the bar, perhaps by use of a clutch that removes its guide pin from the track, through a preferably shortened path to the top of the spindle, thereby to minimize electricity use on the return phase of its up-down or oscillating motion. An array of plural ones of such generators within a building can be operated concurrently but out-of-phase such that one is generating electricity during its ‘fall’ while another is using some of the building's stored energy during its ‘rise.’ Or if the cycle time is made to be as long, for example, as an hour or a day, the ‘rise’ and ‘fall’ can be made to be synchronized with zero and peak demand times of day, thereby to spread more efficiently the spent and stored energy. These and other configurations of disk and bar are shown in schematic form in FIGS. 1A-1C below.

Thus, a so-called mechanical “commutator” analogous to an electrical, field- or polarity-reversing commutator of an electric motor, is contemplated in accordance with the invention. Such a commutator effectively reverses the mechanical polarity or vertical orientation of the assembly containing the disk mechanism and the bar mechanism such that one or more disks that have traversed the bar from top to bottom are restored (whether by lifting the disk along the bar, helical rotation of the disk about the bar, or by semi-circular rotation of the entire disk-bar assembly) from a zero-potential elevation to a maximum-potential elevation. Such reversal or commutation renders the disks ready for another cyclic (downward, under the force of gravity) traversal of the bar, as will be understood by those of skill in the art.

In accordance with this first embodiment of the invention, plural weights or disks can be at different elevations ‘falling’ down the same bar, whereby the energy output is multiplied for a given bar. Or plural spindles each having one or more such ‘falling’ weights can provide even more energy output multiplication. Or, very simply, the ‘falling’ weight can be increased in mass to produce more energy. Or the sliding or rolling friction can be reduced to increase effective energy production.

Those of skill in the art will appreciate that the one or more disks rotating helically along the bar preferably are substantially smoothly polished, right-cylindrically shaped, and rotationally balanced to minimize slippage, stuttering, and excessive friction while traversing the bar. Those of skill in the art also will appreciate that the bar itself preferably is substantially smoothly polished, and generally right-cylindrically shaped but with a helical twist along its substantial height. Those of skill also will appreciate that rolling friction generally is less than sliding friction, and that ball or roller bearings are preferable between the helically rotating one or more disks and their corresponding helically twisted bar. Finally, those of skill will appreciate that materials and coatings have different coefficients of friction that deleteriously can increase the overall inertia of the invented system, while the converse is also true such that a proper choice of materials and coating beneficially can increase the overall rotating momentum and efficiency of electrical power generation.

In accordance with the spirit and scope of the invention, a variable-pitch helical region or starting (nearly vertical) stretch of the helically spiral can have a much greater (e.g. nearly vertical) spiral pitch than the rest of the fixed-pitch helical spiral, thereby to provide an effective kick-start of the angular momentum of the weight from the top of the bar where it initially has inertia or lack of momentum. Or another kick-start mechanism, e.g. a spring, a kick-start motor, or any other device suitable for getting the disk up to a desired helically rotating speed before it ‘falls’, can be provided. A clutch can be provided near the base of the bar that enables the weight to continue to rotate freely there at great but declining speed to produce a flywheel effect that extends the energy-productive period of time for each traverse of the bar. A torque converter can be added to the generator component such that the weight, though traversing the bar at variable speed, nevertheless produces constant electrical energy. These and other alternatives are contemplated as being within the spirit and scope of the invention.

Gravity Generator and On-Demand Energy Storage Device Concept:
These systems contain no chemicals, but function as storage devices that can release energy on demand.
These systems can be used as stand alone or as “complement” devices for other energy sources that have limitations.
Use abundant source to store energy in systems for on-demand release:
   Use solar energy during day to store energy and release/use during night when solar panels cannot produce energy.
   Use wind generators during windy times and release/use during stall or no wind conditions.
   Use off-peak and excess energy at night and release/use during peak demand times to sell power back to the grid.
   Utilize existing resources, like elevators, to store potential throughout the day and release/use as needed.
Use as emergency storage: Lift many disks to store energy and release/use the energy during emergencies or on demand.
The systems can be setup to be used as a generating plant in any habitat, in urban or rural areas, and can provide clean and safe energy without expensive and lossy transmission lines.
The systems can be built above or underground since they do not directly need or rely on natural resources like sun light, wind, or hydropower.

Twisted Bar Configuration:

The disk (referred to herein as a “disk structure”) encircles and drops and rotates along an elongate, central, substantially vertically extending bar (referred to herein as a “bar structure”) or long spindle such as a long twisted square, flat or round bar, cable or cord. The tightness of the twists (the “pitch”) is used to calibrate the speed of ‘fall’ and rotation. Steeper and reduced numbers of twists result in rapid decent and speedy rotation. A smaller pitch and a greater number of the twists will result in slower decent and slower rotation. Those of skill in the art will appreciate that the bar has a helical “thread” portion on its exterior that engages for controlled rotation with a corresponding interior helical “thread” region of the disk.

FIG. 1A features a square bar twist and disk opening pattern with small ball bearings or wheels as guides. FIG. 1B features a flat bar twist and disk opening pattern. FIG. 1C features a two-cable or bar twist and disk opening pattern. Bar types may be seen to include:
A. Twisted square bar (four contact surfaces/tracks)—See FIG. 1A
   a. Requires ball bearings or wheels that have low to no friction.
   b. Ball bearings are calibrated to align to the twisted bar groves.
   c. Brake mechanisms can be used to control the rate of decent and rotation as well as to stop the disks at the bottom to avoid damage to the disk system.
   d. Emergency sensors will also be able to retract the bearings or the wheels, in case of emergency or malfunction.
   e. The disk can engage in a “spin down” mechanism at the bottom and can be allowed to spin down completely (instead of applying brakes), before resetting (commutating; reversing; inverting) the system.
B. Twisted flat bar (Two contact surfaces/tracks)—See FIG. 1B:
   a. This is a tighter configuration than the square bar configuration. This configuration can be implemented without bearings or wheels for light applications. Only two bearings or wheels are required for heavy duty applications. Low-friction coating and lubrication are used on the bar and disk, for non-bearing or wheel applications.
C. Twisted cables, round bars, or ropes—See FIG. 1C:
   a. This configuration can be used for light duty applications with ball bearings. Twisted rope application is also ideal for tall structures, wherein the twisted cables can be stretched and tightened for quick and lower-cost retrofitting. Low-friction coating and lubrication will be used on the bar and disk, for non-bearing or wheel applications.

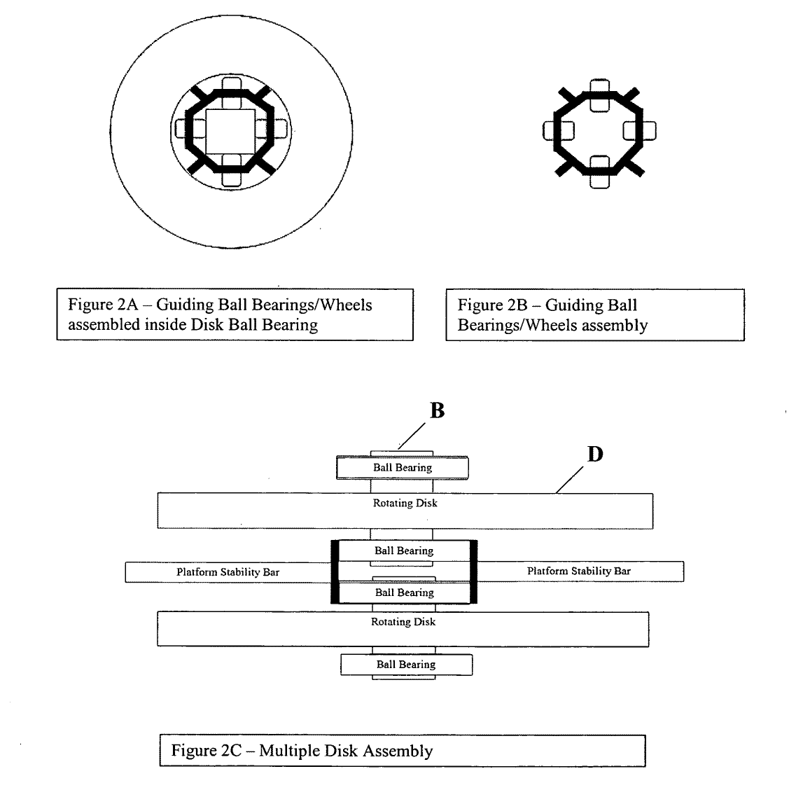

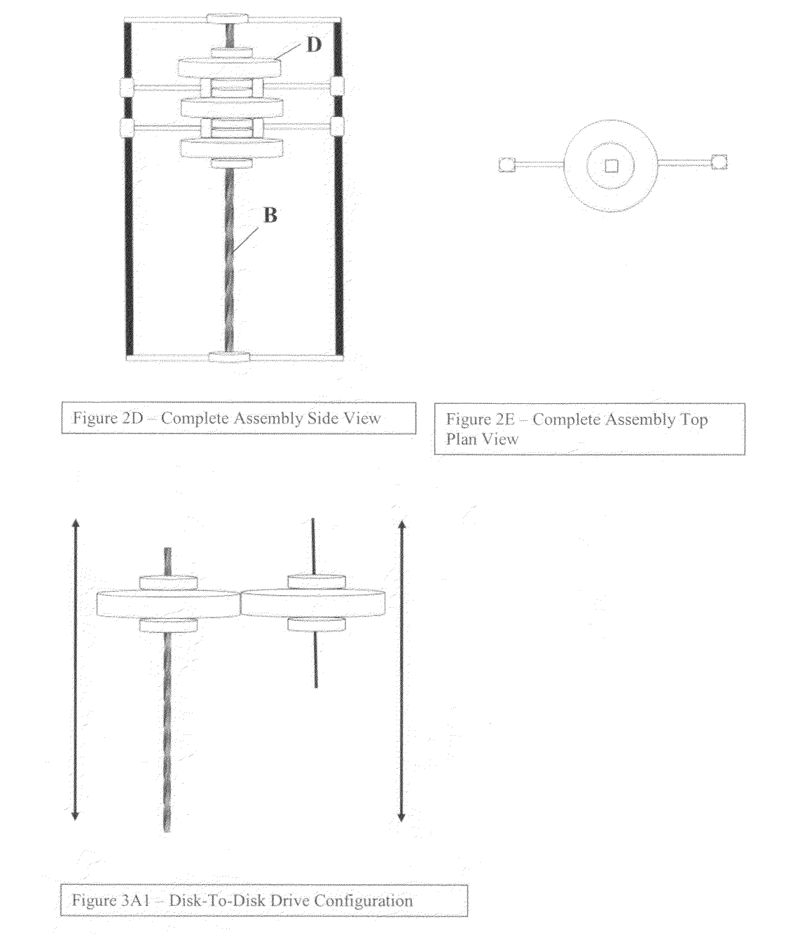

FIG. 2A features guiding ball bearings/wheels assembled inside disk ball bearings. FIG. 2A is believed to be largely self-explanatory.

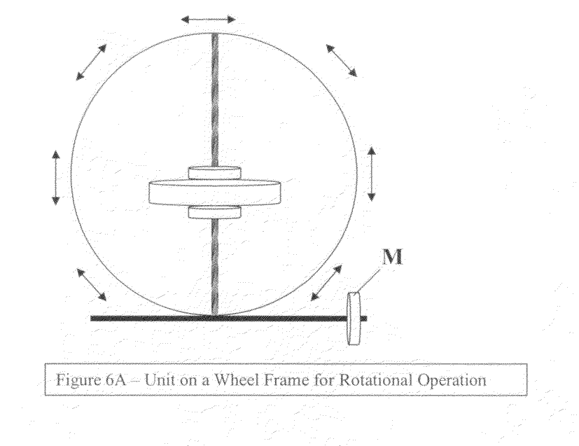

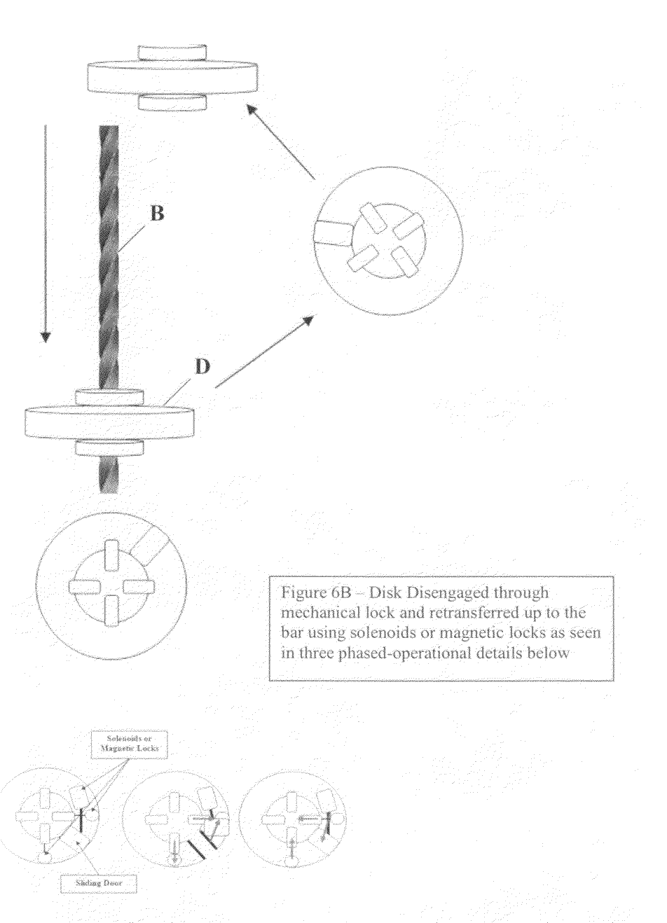

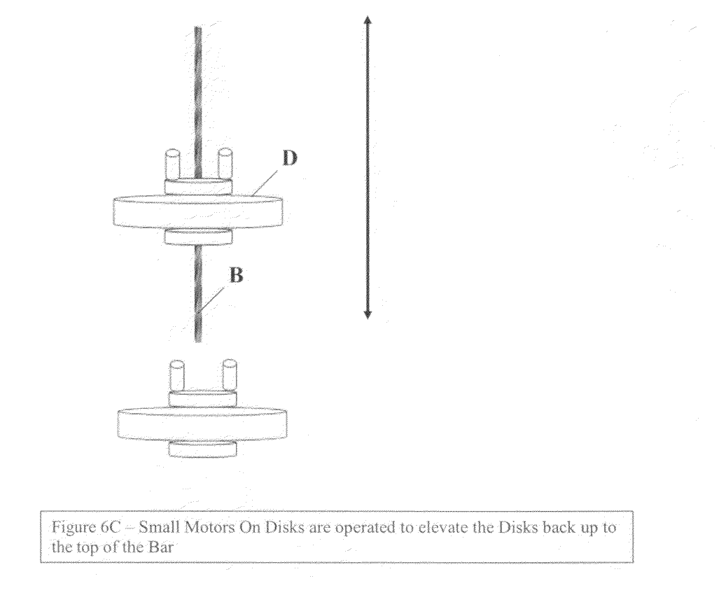

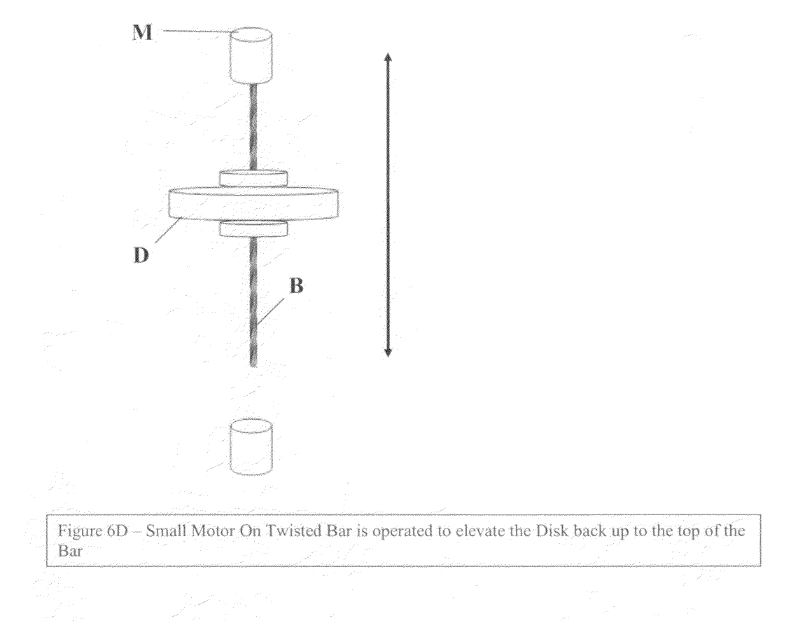

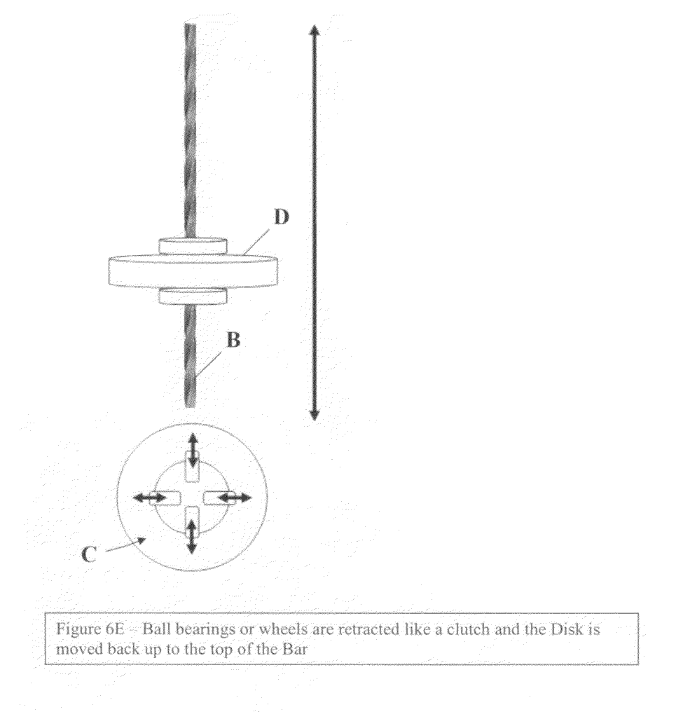

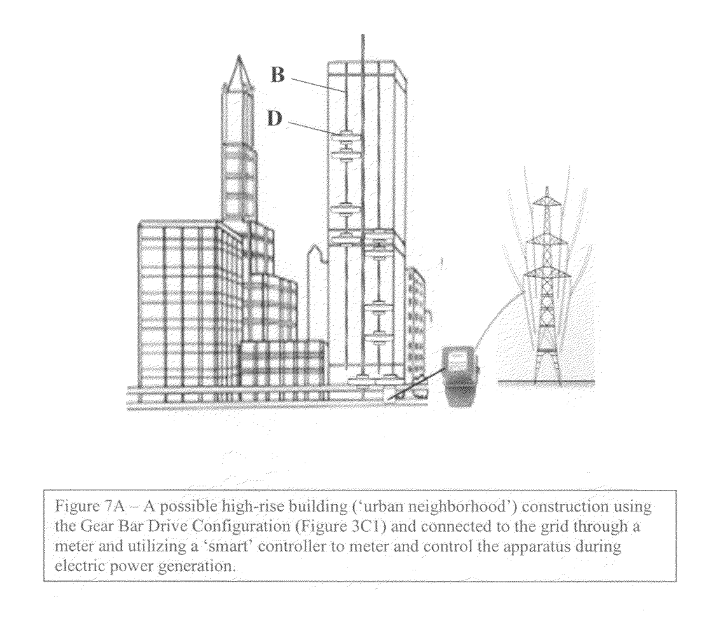

FIG. 2B features a guiding ball bearings/wheels assembly. Small ball bearings or wheels are used to guide the disk along the twisted bar grooves. A brake mechanism can be implemented on the bearings and wheels to control the speed of rotation and brake as required. The bearings and wheels are retractable (effectively providing a clutch) to allow for maintenance and lifting along the bar, if that configuration is used. (See FIG. 6E.)

FIG. 2C schematically illustrates a multiple disk assembly. Ball bearings are used to allow for free rotation of the disk. The disks are assembled to the inner ring of the ball bearings, while system assembly and connections to other disks are made using the outer rings of the ball bearings. This allows for free and independent rotation of each disk as it travels along the twisted bars. The disks can be assembled as single units or multiple disks can be connected together to increase the potential energy being harvested. The system is secured to the frames via platform stability bars, which are connected to the outer ball bearing rings and move up and down along stationary chassis bars.

FIG. 2D features a complete assembly side view in accordance with one embodiment of the invention. FIG. 2D is believed to be largely self-explanatory.

FIG. 2E features a complete assembly top plan view in accordance with one embodiment of the invention. The horizontal stability bars are used to stabilize the platform and mount necessary components that have to remain stationary as the disks rotate. The stability bars move up and down freely along an outer, vertical pair of stationary bars. Ball bearings, pads, or lubrication can be used to minimize friction as the stability bars move about the stationary bars.

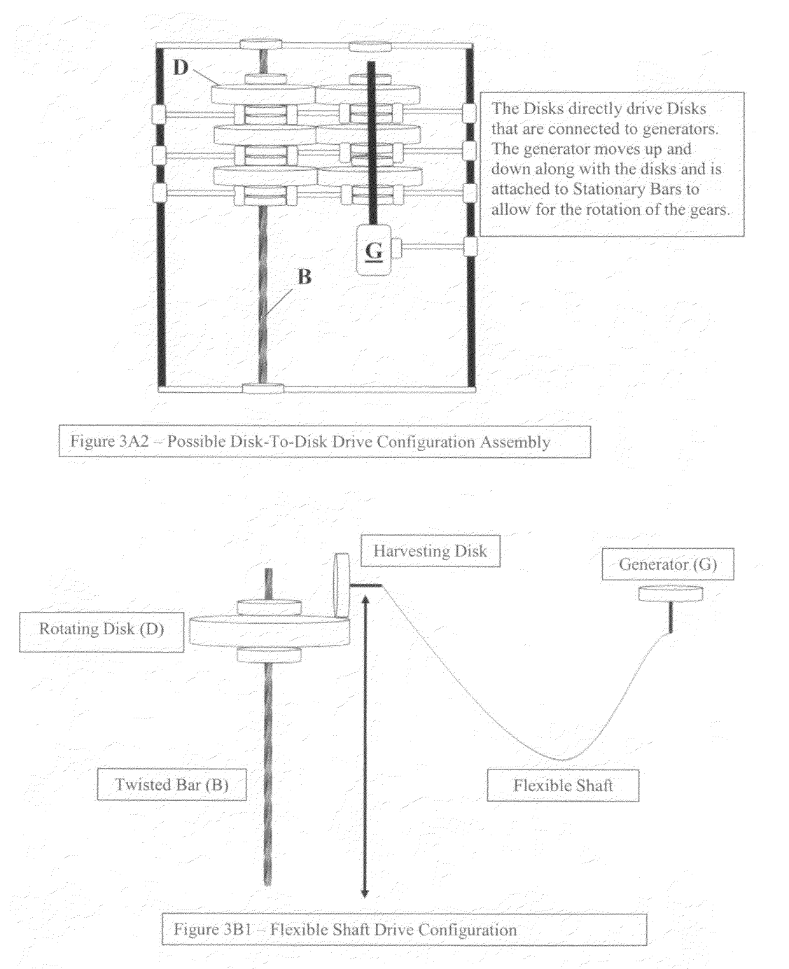

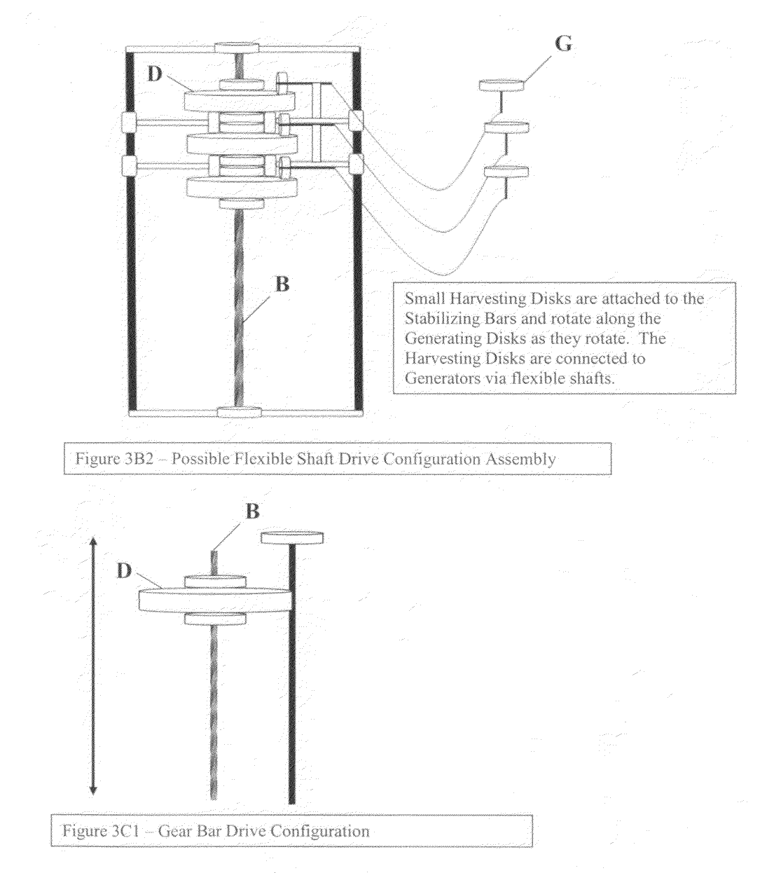

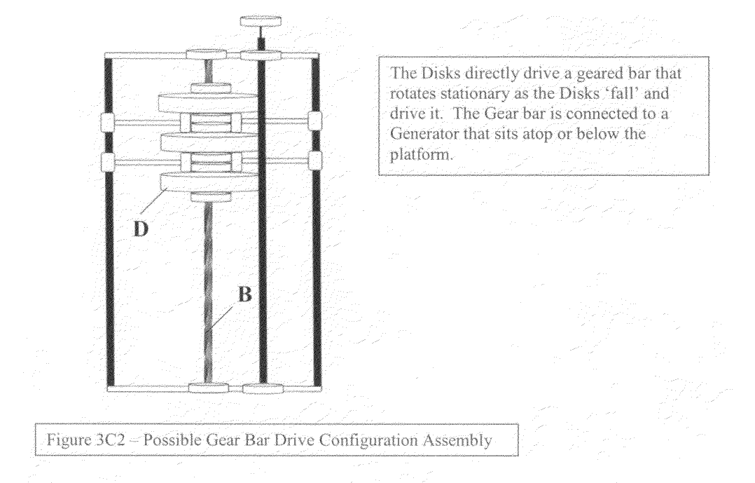

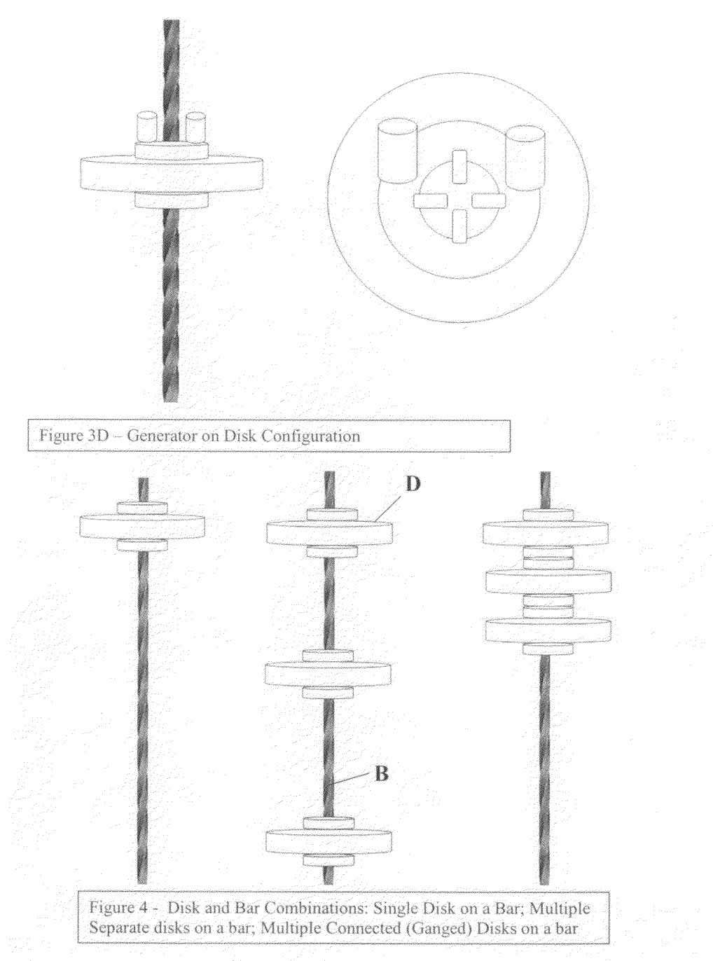

FIG. 3A1 features a disk-to-disk drive configuration in accordance with one embodiment of the invention. The disks directly drive disks that are connected to generators. The generator moves up and down along with the disks and is attached to stationary bars to allow for the rotation of the generator's gears.

FIG. 3A2 features a possible disk-to-disk drive configuration assembly in accordance with one embodiment of the invention. Small harvesting disks are attached to the stabilizing bars and rotate along with the drive disk(s) to convey kinetic energy from the ‘falling’ drive disk(s) to the generator(s).

FIG. 3B1 features a flexible shaft drive configuration in accordance with one embodiment of the invention. FIG. 3B1 is believed to be largely self-explanatory.

FIG. 3B2 features a possible flexible shaft drive configuration assembly in accordance with one embodiment of the invention. FIG. 3B2 is believed to be largely self-explanatory.

FIG. 3C1 features a gear bar drive configuration in accordance with one embodiment of the invention. The Disks directly drive a geared bar that rotates stationary as the disks ‘fall’ and drive it. The gear bar is connected to a generator that sits atop or below the platform.

FIG. 3C2 features a possible gear bar drive configuration assembly in accordance with one embodiment of the invention. FIG. 3C2 is believed to be largely self-explanatory.

FIG. 3D features a generator on disk configuration in accordance with one embodiment of the invention. This technology utilizes one or more new configuration generators that can be modified to traverse the twisted bars and to generate energy as each of the one or more generator travel along the bars. This minimizes the cabling problems and eliminates the need for the flexible shaft drive configurations of FIG. 3B1 or 3B2.

FIG. 4 features disk and bar combinations: single disk on a bar; multiple separate disks on a bar; and/or multiple connected (ganged) disks on a bar. FIG. 4 is believed to be largely self-explanatory.

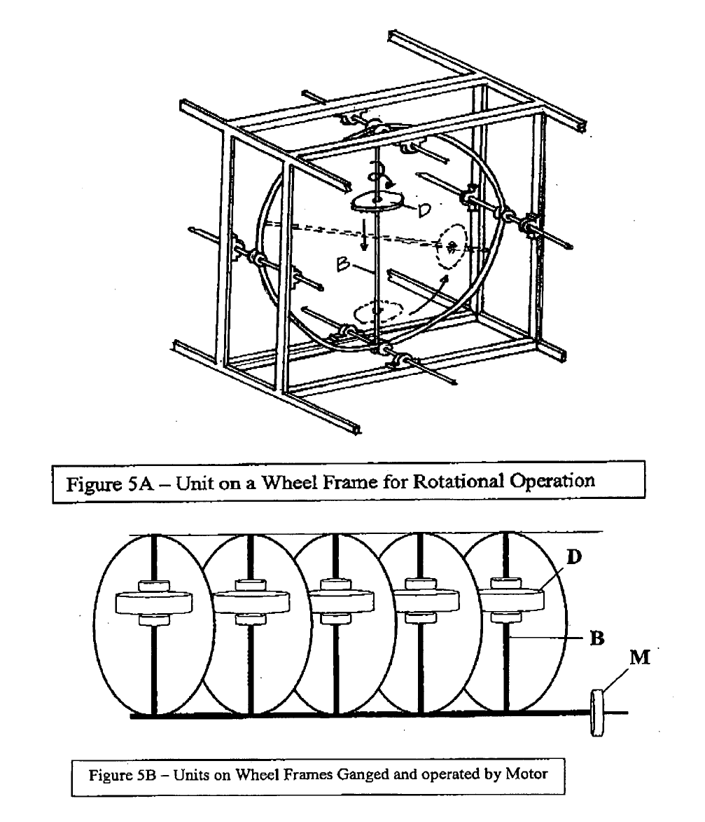

FIG. 5A features a unit-on-a-wheel frame for rotational operation in accordance with one embodiment of the invention. FIG. 5A is believed to be largely self-explanatory. It will be understood that upper and lower horizontal frame members are referred to herein respectively as cap and base structures fixedly mounting bar B. See also FIGS. 2D, 3A2, 3B2, 3C2, and 7B.

FIG. 5B features units on wheel frames ganged and operated by motor in accordance with one embodiment of the invention. FIG. 5B is believed to be largely self-explanatory.

System Reset and Reload (Commutation or Return Mechanism) Configurations:

FIGS. 6A-6E illustrate various commutation configurations by which, at the end of the disk's ‘fall’, the disk is restored to a position near the top of the bar in what will be described herein as cyclic operation. FIGS. 6A-6E are believed to be largely self-explanatory.

FIG. 6A features a system on a wheel frame for rotational operation in accordance with one embodiment of the invention. A motor M and a worm gear (for example, not shown) for rotating the assembly including the disk and bar are featured.

FIG. 6B features a disk disengaged through mechanical lock and retransferred up to the bar using solenoids or magnetic locks as seen in three phased-operational details below.

FIG. 6C features small motors on disks operated to elevate the disks back up to the top of the bar in accordance with one embodiment of the invention.

FIG. 6D features a small motor on a twisted bar operated to elevate the disk back up to the top of the bar in accordance with one embodiment of the invention.

FIG. 6E features ball bearings or wheels retracted like a clutch and the disk moved back up to the top of the bar in accordance with one embodiment of the invention.

In all embodiments of the system, kinetic energy of a ‘falling’ object is converted and stored in a capacitor, inductor, or other suitable power-storage component as electrical energy (or, alternatively, is used to charge a battery or feed directly into the electric grid as a quantified energy credit), and then the object is returned via a preferably more energy-efficient drive means (or at least over a more efficient time-energy curve) to its original position to repeat the ‘fall’ cyclically. In some embodiments, the weight of the gravity-influenced object can be adjusted so that it is less on the return path than on the ‘fall’ or drive path (e.g. as by taking on dense material at the top and discharging the dense material at the bottom). It is believed that a dense object threaded on a screw drive spindle or rod can produce significant electrical energy during its ‘fall’.

The variable-disk-mass configuration mentioned above can be realized by using a disk-shaped, ballast-fillable, preferably sealed container that helically traverses the bar. The ballast or filler material can take the form of lead shot, water, or other material of desired density to produce a weighted disk of desired mass. Water or other material can be discharged from the disk-shaped container at the bottom of the bar and reintroduced at the top of the bar, thus providing a differential mechanical advantage in the cyclic ‘rise’ and ‘fall’ of the disk that increases power conversion efficiencies. A pump and/or cistern and/or storage tank and/or a water tower and the like can be used to supply and store water. This ballast-filled disk-shaped container used in accordance with the invention also advantageously permits the mass of the helically ‘falling’ weight to be automatically or manually varied to accommodate different power demand or efficiency needs.

Finally, it will be appreciated by those skilled in the art that the disk's elevation at the top of the bar can be restored by any suitable means including mechanical means. Thus, in rural and more sparsely populated areas of larger countries such as India, manual labor can be used to power a rope or cable or chain and pulley lift system, for example, to enable the disk to be returned to the top of the bar to restore its power-producing potential energy. Manual labor will be understood broadly to include human or animal labor. Other means of elevating the helically rotating disk are contemplated as being within the spirit and scope of the invention.

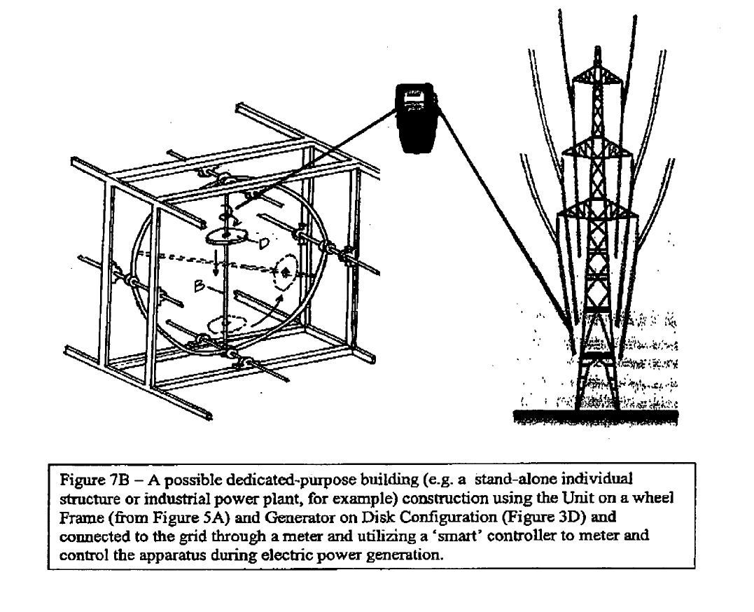

Even if the invented apparatus is less than 100% efficient—which it very likely is not despite due concern for shorter, lower-mass, and/or lower-friction return paths than drive paths for the object—nevertheless the efficiency of such systems is believed to justify the cost, as electricity can be used locally within a building (refer briefly to FIGS. 7A and 7B), thereby obviating economically costly and relatively high-loss energy power distribution over long distances. Moreover, net overall savings can be had by operating such systems such that they generate electricity during peak demand and drain energy during zero or low demand, thereby achieving net energy cost savings. Taxing of fossil fuels or other limited-supply feedstock is greatly reduced, and unsightly and costly power distribution networks are avoided, since the invention involves containing local electrical energy production and use within a house, building, high-rise, complex, block, or neighborhood.

Those of skill in the art will appreciate that alternative arrangements, numbers, and configurations of components than those illustrated and described herein are contemplated as being within the spirit and scope of the invention. Those of skill in the art also will appreciate that any suitable materials, dimensions, and operative couplings are contemplated also as being within the spirit and scope of the invention. Thus the hardware components, numbers, arrangements and configurations described and illustrated herein will be understood to be illustrative only and not limiting of the myriad possibilities enabled by the instant invention.

FIGS. 7A and 7B illustrate alternative electrical power generation systems installed within a high-rise (e.g. condominium) or stand-alone (e.g. power plant) building, for example, wherein two or more such apparatus as those described above are ‘ganged’ together in series and/or parallel to multiply and/or level (e.g. average) electrical energy production. Those of skill in the art will appreciate that a grid meter/coupler can provide metrics to the utility or grid owner that ensure a proper credit to the high-rise building's owner or operator when excess power is delivered to the grid.

Those of skill in the art also will appreciate that a software- and/or firmware- and/or hardware-based controller, e.g. a special-purpose (specially programmed) digital computer or microprocessor executing stored instructions residing in a memory, can provide further functionality to the high-rise building's owner or operator. For example, a so-called “smart” controller can meter and control bar/disk interface solenoids, can stagger starts and stops to match power demand/supply, can log power generation efficiencies, can monitor excess power credits, and can otherwise suitably assist operational optimization by the owner/operator of the high-rise in which the power is generated. All such suitable uses of a smart controller operatively coupled with the invented power generating apparatus are contemplated, and are within the spirit and scope of the invention.

FIG. 7A features a possible high-rise building ‘urban neighborhood’ construction using the gear bar drive configuration (see FIG. 3C1) and connected to the grid through a meter and utilizing a ‘smart’ controller to meter and control the apparatus during electric power generation.

FIG. 7B features a possible dedicated-purpose building (e.g. a stand-alone individual structure or industrial power plant, for example) construction using the unit-on-a-wheel frame (see FIG. 5A) and generator-on-disk configuration (see FIG. 3D) and connected to the grid through a meter and utilizing a ‘smart’ controller to meter and control the apparatus during electric power generation.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. Rotating-energy electrical production system comprising:
an elongate central substantially vertically extending bar structure including an exterior helical thread portion extending therearound from an upper region thereof to lower region thereof, and
a disk structure encircling the bar structure, the disk structure having an interior helical thread portion engaging the exterior helical thread portion of the bar structure for helically winding counter-rotation therebetween under the force of gravity acting on the disk structure.

2. The system of claim 1, wherein the bar structure is fixed against rotation, and wherein the disk structure rotates around the bar structure.

3. The system of claim 2 further comprising:
a base structure fixedly mounting the top of the bar structure; and
a cap structure fixedly mounting the bottom of the bar structure.

4. The system of claim 3 further comprising:
a generator operatively coupled to the disk structure for converting helically rotational kinetic energy thereof to electric energy during a downward helical traverse of the disk structure.

5. The system of claim 4, wherein the generator is connected to the disk structure.

6. The system of claim 4, wherein the disk structure is coupled with the bar structure for helical rotation therearound via one or more bearings.

7. The system of claim 6, wherein the one or more bearings includes one or more ball bearings.

8. The system of claim 7 further comprising:
a return mechanism for return of the disk structure from the lower region of the bar structure to the upper region of the bar structure after a downward helical traverse thereof.

9. The system of claim 8, wherein the return mechanism includes a clutch mechanism for altering resistance dynamics of a return traverse relative to resistance dynamics of the downward traverse of the disk.

10. The system of claim 8, wherein the return mechanism includes a commutator mechanism for reversing the up-and-down orientation of an assembly including the bar structure and the disk structure after each helically rotation traverse of the former by the latter.

11. The system of claim 8, wherein the return mechanism is electrically powered.

12. The system of claim 8, wherein the return mechanism is manually powered.

13. The system of claim 8 further comprising:
an electrical grid connected to the generator.

14. The system of claim 13, wherein the grid is a part of a metered utility.

15. The system of claim 13, wherein the grid is a part of a building.
